(19) United States
(12) Patent Application Publication
(10) Pub. No.: US 2009/0154812 A1
(43) Pub. Date: Jun. 18, 2009

(54) Method for Identifying Objects and Object Identification System

(76) Inventor: Klemens Schmitt, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/224,405

(22) PCT Filed: Feb. 26, 2007
(86) PCT No.: PCT/EP2007/051797

§ 371 Date: Dec. 10, 2008

(30) Foreign Application Priority Data
Feb. 27, 2006 (DE) 102006008936.7

(51) Int. Cl. G06K 9/48

(52) U.S. Cl. 382/199

(57) ABSTRACT

A method for identifying objects using an object identification system, wherein a respective pattern of an object to be identified is taught to the object processing system in the form of a pattern edge image formed from edge points, wherein at least one image which is recorded using an image recording unit and is to be examined is subsequently examined for the presence of an object that corresponds to a relevant pattern by comparing edge points in the recorded image with edge points in the pattern edge image, wherein an overall quality value is determined as a measure of correspondence between the object and the pattern, is distinguished by the fact that an association with lines in the pattern is then determined for the edge points of the pattern by finding edge points with essentially the same orientation.

### CROSS REFERENCE TO RELATED APPLICATIONS

This application is the US National Stage of International Application No. PCT/EP2007/05 1797, filed Feb. 26, 2007 and claims the benefit thereof. The International Application claims the benefits of German application No. 10 2006 008 936.7 filed Feb. 27, 2006, both of the applications are incorporated by reference herein in their entirety.

### FIELD OF INVENTION

The present invention relates to a method for identifying objects in accordance with the claims, wherein a respective pattern of an object to be identified is taught to the object processing system in the form of a pattern edge image formed from edge points, wherein at least one image which is recorded using an image recording unit and is to be examined is subsequently examined for the presence of an object that corresponds to the relevant pattern by comparing edge points in the recorded image with edge points in the pattern edge image, wherein an overall quality value is determined as a measure of correspondence between the object and the pattern.

The present invention further relates to an object identification system in accordance with the claims, with an image recording unit for recording pattern and object images and with an image processing unit which is embodied for creating edge images from the recorded pattern and object images, with at least one pattern of an object to be searched for in a recorded image in the form of an edge image comprising edge points being taught for a comparison with edge points in the recorded image by which an overall quality value is able to be determined for a correspondence between the object and the pattern.

In addition the present invention relates to a computer program product in accordance with the claims, especially for use in an object identification system with an image recording unit for recording pattern and object images and with an image processing unit which is embodied for creating edge images from the recorded pattern and object images, with at least one pattern of an object to be searched for being taught in the image identification system in the form of an edge image comprising edge points.

### BACKGROUND OF THE INVENTION

For identification of objects by means of an object identification system the practice is known of initially teaching the image of a pattern to be searched for in the form of an edge image comprising edge points (“pattern edge image”) and subsequently comparing recorded images of objects, so-called object images, likewise in the form of edge images (“object edge image”) with the pattern edge image, with a corresponding quality value being determined during the comparison as a measure of the correspondence. As from a specific quality value, also referred to within the context of this application as the “overall quality value”, the object is assessed as identified, i.e. the object identification system indicates that an object essentially corresponding to the pattern was found in the recorded image. The individual edge points themselves have an amount (the edge strength in this point) and an orientation, which is known to the person skilled in the art.

With these types of method a rough search is initially conducted on a regular basis in the recorded image, for example by means of a so-called pyramid method, in order to localize at least approximately an object to be compared with the pattern in respect of location and orientation (“localization”). At present such a localization is followed by a detailed search, but with lower subsampling, which however only inadequately implements the classification between good and bad parts, i.e. between those objects which essentially correspond to the taught pattern, and other objects (which do not correspond to the pattern or are a bad correspondence with it). In this way bad parts are often assigned quality values actually corresponding to good parts, so that the difference in the quality value between correctly identified good parts and incorrectly identified bad parts—known as the signal-to-noise ratio—is too small in individual cases. With previously-known methods it can even occur in unfavorable cases that a bad part is given a better quality value than a good part.

Furthermore, with previously-known methods for object identification it is to be seen as disadvantageous that larger patterns tend to possess lower quality values than smaller patterns, which also makes a reliable classification more difficult.

Because of the fact that, with currently known methods in the detailed search for the comparison—the so-called correlation—simply a higher number of edge points than for localization is used, individual edge points may not differ in the comparison, but this is especially regularly the case with image distortions, if for example the camera is not aligned at right angles to the image plane. Further, with previously-known methods, edge points found correctly at random in the image can incorrectly drive the quality value upwards.

A method in accordance with the preamble of claim 1 is to be found in the document Gao, Y. and Leung, M., “Line segment Hausdorff distance on face scan matching”, Pattern Recognition, vol. 35, pp. 361-371, 2002. The document relates to the identification of faces and deals with a new concept relating to the “Line segment Hausdorff distance”. In this case pattern edge images are compared with one another, with dominant points such as for example the end points of the relevant line segments being used during comparison of line segments of the images. Furthermore the orientation of the lines is evaluated, which enables lines with greatly differing orientation to be removed for example.

Furthermore a method is known from US 2005/0169531 A1 for image processing, by means of which edges, lines and rectangles are to be reliably detected. For detection of edges the contrast as well as the gradient of a pixel are used. From the edge points obtained lines are then created, with for example the amount and the orientation of the edge point as well as the line length able to be taken into account by using a gradient-weighted Hough transformation.

In the method described in said publication calculations are first performed with the established edge points for determining a line, with a value being determined for each edge point which is needed for further line determination. In the further line determination the largest local maximum of the values established beforehand is used which is greater than a threshold value. The threshold value is proportional to the minimum expected length of the. lines. If no such maximum is present, the method is ended. If a local maximum is present, this is marked, so that it is not taken into consideration again in the rest of the method, and the edge points are determined, which are located within a predetermined distance of the straight lines established by means of the Hough transformation which goes through the local maximum. The edge points determined are then connected to each other.

The disadvantage of the known method it is that, for determining a line, calculations must be performed beforehand and the minimal length of a line must be known.

### SUMMARY OF INVENTION

The object of the invention is to further develop a method and a system of the type stated at the outset to the extent that more reliable classifications of good and bad parts are possible.

The object is achieved for a method of the type stated at the outset by the characterizing features of the claims. Furthermore the object is achieved with an object identification system of the type stated at the outset by the characterizing features of the claims. In addition the object is achieved for a computer program product of the type stated at the outset by the characterizing features of the claims.

Advantageous embodiments of the inventive method are the subject matter of subclaims.

In accordance with the present invention a method for identifying objects using an object identification system, with a pattern of an object to be identified in the form of pattern edge image from edge points being taught to the object processing system and subsequently at least one image to be examined recorded by means of an image recording unit being examined for the presence of an object corresponding to the pattern, in that edge points in the recorded image are compared with edge points of the pattern edge image, with an overall quality value being determined as a measure for the correspondence between the object and the pattern, characterized in that, subsequently for the edge points of the pattern, by finding edge points with essentially the same orientation, an association with lines in the pattern is determined and that an edge point in the recorded image is assessed as an object corresponding to the pattern if a predetermined number of neighboring edge points of the relevant edge point have an orientation essentially corresponding to the orientation of a line of the pattern.

Furthermore, in accordance with the invention, an object identification system with an image recording unit for recording pattern and object images and with an image processing unit which is embodied for creating edge images from the recorded pattern and object images, with at least one pattern of an object to be searched for in a recorded image in the form of an edge image comprising edge points is taught for a comparison with edge points in the recorded image, through which an overall quality value for a correspondence between the object and the pattern is able to be determined, characterized in that the image processing unit is embodied to execute the inventive method.

In addition a computer program product, especially for use in an object identification system with an image recording unit for recording pattern and object images and with an image processing unit which is embodied for creating edge images from the recorded pattern and object images, with at least a pattern of an object to be searched for in the form of a an edge image comprising edge points being taught to the object identification system, characterized by program code sequences, during the execution of which, especially in the image processing unit, a method as described in the claims is executed.

The proposed approach to a solution is based on the knowledge that a quality value with an improved signal-to-noise ratio can be specified if, unlike with conventional methods, greater consideration is given to the line to which the edge point belongs during correlation. More reliable qualifications are possible in this way.

Accordingly there is provision in a development of the inventive method for a line quality value to be increased for each edge point assessed as belonging to the object corresponding to the pattern.

To tolerate lower tolerances with image distortions, especially if an image recording unit (camera) used is not aligned at right angles to the image plane, each line of the pattern is inventively individually correlated and the maximum amplitude of the result is added into the overall quality value. Accordingly there is provision in a development of the inventive method for each line of the pattern to be compared individually with the edge points of the recorded image and for a corresponding maximum line quality value to be added to an overall quality value. A preferred value for the tolerance amounts in each case to ±1 pixel in two directions of the image plane at right angles to one another, e.g. in the x and y direction. The recorded image or the area determined in the course of localization are displaced around this value in order to discover the maximum line quality value.

To be able to react as flexibly as possible to these types of tolerances, the lines observed should not be of a disproportionate length. There is thus provision in a development of the inventive method for limiting a length of the line of the patterns to a predetermined maximum value. In specific applications it has proved advantageous to truncate the lines to a maximum length of 100 pixels.

The relative orientation between pattern edge points and object edge points represents via the formation of the scalar product the decisive element of the correlation. To weight strong edges of the pattern more heavily in the sense of outstanding features of this pattern during the correlation, in a development of the inventive method there is provision for the scalar product to be formed from an orientation of a pattern edge point and an orientation of an edge point of the recorded image during comparison of edge points, with the corresponding value of the scalar product being weighted with a weighting factor before being accepted into a line quality value.

In a development of the inventive method there is provision, for determining the weighting factor, for the determination of the weighting factor, starting from an initial value, to include the steps listed below:
a) Adding an actual edge strength in the edge points of a line of the pattern into the initial value,
b) Adding a respective edge strength in step a) of neighboring edge points of the relevant edge points of the line of the pattern not taken into consideration to the result from step a) for determining an expanded edge strength of the line of the pattern in each case,
c) Repeating steps a) and b) for all line of the patterns and determining a maximum value for the expanded edge strength of the line of the patterns,
d) Normalizing the values for the edge strength of all edge points to the maximum value,
e) Multiplying all normalized values for the edge strength by the value for the actual edge strength in the corresponding edge point.

The weighting of the edge strength described here implements a pseudo-quadratic algorithm, which advantageously acts on the required memory space and the (numerical) processing speed.

To supplement the line correlation described above and for improving its efficiency, in a development of the inventive method there is provision, for a number of edge points in the recorded image, for an orientation value at right angles to a line of the pattern to be compared in each case with a predetermined orientation threshold and for only edge points with an orientation value exceeding the orientation threshold value to be included in the determination of the overall quality value. Here too, preferably in a specific tolerance interval around the position of the object or object image respectively found during the localization, a search is made for a maximum gradient at right angles to the line of the pattern and this maximum value is compared with the orientation threshold value.

To further prevent too many unclean (“lower-value”) edges increasing the quality value disproportionately, which would lead to an uncertain qualification, in a development of the inventive method there is provision that, for a number of edge points in the recorded image an edge threshold value is set and that only such edge points are included in the determination of the overall quality value of which the contribution to the edge strength, i.e. their value for the edge strength, exceeds the edge threshold value.

The inventive provision of these threshold values reduces a watering-down of the quality value.

As part of an improved user-friendliness and for the purposes of an improved utilization of system resources, especially as regards memory space requirements and speed of processing, in a development of the inventive method there is provision for the orientation threshold value and/or edge threshold value to be generated automatically as a function of a number of found edge points in the recorded image.

To enable the advantages of line correlation to be used to their optimum, another development of the inventive method makes provision for line fragments of the pattern to be expanded into complete lines before the comparison.

### BRIEF DESCRIPTION OF THE DRAWINGS

Further characteristics and advantages of the present invention emerge from the subsequent description of a exemplary embodiment with reference to the drawing.

The Figures show:

FIG. 1 a schematic block diagram of an inventive object identification system,

FIG. 2 a structured flowchart of a inventive method and

FIG. 3 a more detailed structured flowchart of a method step in accordance with FIG. 2.

### DETAILED DESCRIPTION OF INVENTION

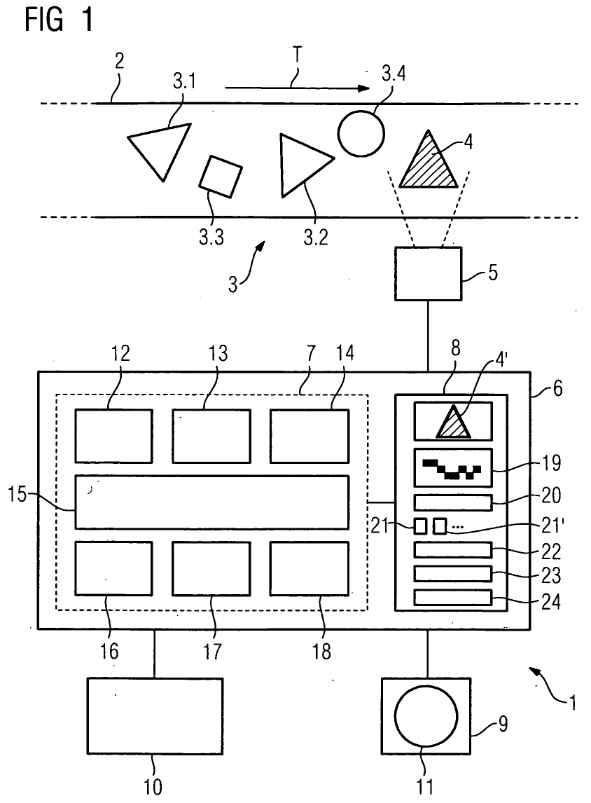

FIG. 1 shows, on the basis of a schematic block diagram, an embodiment of the inventive object identification system 1. In accordance with FIG. 1 the object identification system 1 is embodied for identification of objects 3.1, 3.2 located on a conveyor device 2 by comparison with a pattern 4 (pattern object), with the objects 3.1, 3.2 as well as further objects 3.3, 3.4 being moved in a direction of transport T of the conveyor device 2.

For this purpose the inventive object identification system 1 features an image recording unit 5 which is effectively connected for signaling to an image processing unit 6. The image processing unit 6 contains a data processing unit 7 and a memory unit 8. Furthermore an input device 9 and an output device 10 are connected to the image processing unit. The input device 9 is embodied, in accordance with the exemplary embodiment shown, for reading suitable machine-readable data media 11. In particular the input device 9 can be a CD-ROM drive, a DVD-ROM drive, a network interface or suchlike. Accordingly the data medium 11 is a CD-ROM, a DVD-ROM or a suitably modulated carrier signal respectively, which is known to the person skilled in the art. In this way the input device 9 especially allows program code sequences for inventive embodiment of the image processing unit 6 or of the data processing unit 7 to be provided.

The output unit 10 is especially a display device, such as a screen or suchlike, or software, which is known per se to the person skilled in the art.

The data processing unit 7 of the image processing unit 6 inventively includes a series of modules 12-18, which according to the aforementioned, are preferably embodied as software modules, with the corresponding program code able to be provided by means of the data medium 11 via the input device 9, as described above.

Inventively the data processing device 7 includes an edge module 12, a line module 13, a storage module 14, a correlation module 15, a threshold value module 16, a quality value module 17 as well as a weighting module 18, with the respective functions of said modules being explained in greater detail below.

During operation of the inventive object identification system 1, an image 4 of a pattern object subsequently to be identified/searched for is first recorded by means of the image identification unit 5. The corresponding image data is transferred by the image recording unit 5 to the image processing unit 6 and processed in the data processing unit 7 there. When this is done, edge points of the recorded pattern image are first determined in a manner known per se using the edge module 12. In other words: The recorded image of the pattern object 4 is converted into an edge image by the edge module 12. The edge points determined in this manner each have an amount (the edge strength) and a direction (the edge orientation), with the latter being oriented at right angles to the course of the edge in the direction of a contrast gradient of the image, as is familiar to the person skilled in the art.

On the basis of the edge image of the pattern object 4 determined in this way an association between a line and the individually found edge points is subsequently determined by the line module 13. A check is performed especially in this case as to whether neighboring edge points of the edge image 4 (also referred to below as the “pattern edge image” 4′) exhibit an orientation matching specific predeterminable limits. If for example two neighboring edge points of the pattern edge image 4′ possess an orientation matching up to a value of 10° (30°), these edge points are assessed as belonging to a common (edge) line in the pattern edge image 4′. These types of line are referred to below as “line of the patterns”. The investigation described above is performed for all found edge points of the pattern edge image 4′. After thinning of the line of the patterns known per se, the pattern edge image 4′ itself is stored in the memory unit 8 of the image processing unit 6.

Subsequently all edge points determined as belonging to a specific line of the pattern are stored by means of the storage module 14 in the form of line data records 19 in a suitable manner in the memory unit 8 of the image processing unit 6, with, for reasons of clarity, only an individual record of these line data records 19 being explicitly shown in FIG. 1. Subsequently, on the basis of the line data records 19, all edge points belonging to a specific line of the pattern edge image 4′ are determined in a simple manner. Corresponding storage algorithms, as are employed within the storage module 14, are known to the person skilled in the art.

Inventively the line module 13 only creates lines or line data records 19 with a line length restricted beyond a predetermined maximum value, which corresponds to a maximum number of edge points of the pattern edge image 4′ linked to a line. This is done in order in the subsequent correlation (see below) to enable lower tolerances as a result of image distortions to be compensated for. Such distortions are especially produced if the image recording unit 5 is not located directly above an object 3.1-3.4 to be observed or as a result of the quantization of the point positions within the recorded image. In practice a restriction of the line length to 100 pixels has been shown to be advantageous.

After the lines to which all the edge points of the pattern edge image 4′ belong has been determined, as described above, images for objects 3.1-3.4 to be examined are recorded gradually by the recording unit 5, with said objects being moved by the conveyor device 2 past the image recording unit 5. According to the embodiment shown, the objects 3.1, 3.2 involved are those objects which are essentially identical to the pattern object 4 and are to be selected accordingly by the inventive object identification system as such, in that they are each assigned a high overall quality value. By contrast, the other objects 3.3, 3.4 shown are those objects which are not to be assessed by the object identification system 1 as being identical to the pattern object 4 (correspondingly lower overall quality value). For this purpose the image of the respective objects 3.1-3.4 recorded by means of the image recording unit is compared in the image processing unit 5 with the pattern edge image 4′ and the overall quality value is determined as a measure for a correspondence between the object 3.1-3.4 and the pattern object 4 or the pattern edge image 4′ and where necessary output via the output device 10.

Within the framework of the said comparison of object (image) and pattern (image) further modules of data processing unit 7 are employed inventively: Initially a corresponding edge image is determined once again using the edge module 12 from the recorded image of an object 3.1-3.4 (“object image”) as already described in detail above for the pattern object 4. The “object edge image” is subsequently compared to the pattern edge image 4′ stored in the memory unit 8. The actual comparison - the correlation - is inventively performed by the correlation module 15 in which the orientation of the edge points is assessed as a priority element. To this end the scalar product between the orientation of a pattern edge point and the orientation of an object edge point is formed in the correlation module 15. In this case a maximum value is then produced for the scalar product if the orientation of an object edge point tallies with the orientation of a pattern edge point. This enables the determined scalar product to be included in each case as a summand for the determination of a quality value.

Inventively the correlation, of which the basic principles have been described above, is calculated for all the line of the patterns determined in the pattern edge image 4′ (line data records 19), with, to avoid isolated good pixels, i.e. pixels which are detected in the object image as belonging to pattern images, being examined by means of the correlation module 15 as to whether a predetermined number of neighboring points of an object edge point observed at the time has the same orientation as a line of the pattern just observed. Only if this condition is fulfilled will a good pixel be positively added to a corresponding line qualify value. This occurs within the quality value module 17, in which a corresponding good counter (see below) is correspondingly maintained for each identified line in the pattern edge image 4′. In this way the correlation inventively takes account of whether object edge points belong to a particular line.

In addition, the invention also takes account during correlation by means of the correlation module 15 of the edge strengths of the individual edges (lines) of the pattern edge image 4′ through an additional weighting. This line-specific weighting factor is inventively determined using the weighting module 18 as follows: For each line (line of the pattern defined by a corresponding line data record 19) of the pattern edge image 4′ the actual edge strengths, i.e. the values of the edge strengths of all edge points of the relevant lines determined using the edge module 12 from the recorded image, are added, starting from an initial value (here specifically the value zero). Subsequently, for each edge point of this line, the values of the edge strength of neighboring edge points (next and next-but-one neighbors) are added in, provided this has not been taken into account in the previous addition step. The neighboring edge points are in particular those edge points which were lost during the creation of the line data records 19 during the course of thinning (see above). Thinning involves a process. in which the edge width or line width respectively is restricted to precisely one pixel, a procedure which is known per se to the person skilled in the art. By adding in the edge strength of neighboring edge points above all small patterns are strengthened in which the lines make many bends. In this way a type of expanded overall edge strength is produced for each line of the pattern edge image.

Subsequently the maximum is determined from the overall edge strengths established. This maximum value can still be divided by a predetermined divisor value, e.g. the value four, in order especially to avoid an overflow of numerical values. For the purposes of normalization each edge point value of the pattern edge image is subsequently again divided by the possibly subdivided maximum value of the overall edge strength. For the purposes of a so-called pseudo-quadratic weighting, each of the edge point values thus divided is multiplied by its previous value, i.e. the actual edge strength in this point.

The pseudo-quadratic algorithm described here has the advantage that a quasi-quadratic weighting of the edge points is possible for the correlation without a disproportionate memory requirement being needed for each individual edge point value. It is possible, especially within the context of the embodiment described here, to work with shorts for the individual edge points, as usual.

The weighting factor 20 determined in this way can inventively be stored in the memory unit 8 of the image processing unit 6 and is thus available to the correlation module 15 for greater consideration of the edge strength during correlation, as previously described in the invention. Alternately the weighting factor can also be applied directly to the stored pattern edge image 4′ so that the latter directly contains the weighting described above.

In accordance with the above each line for which a line data record 19 is present, is correlated individually by the correlation module 15 with the individual object edge points. The correlation module 15 in this case is further embodied to perform a correlation with a respective tolerance of ±1 pixel in two directions in the image plane at right angles to each other, i.e. the pattern edge image 4′ is shifted in each case in one and/or two spatial directions at right angles to each other by a specific number of pixels, after which a correlation between the pattern edge image 4′ and a given object edge image is computed once more by means of the correlation module 15. For each line a maximum correlation result is thus determined and stored as a line quality value 21, 21′, . . . (corresponding to an end value of the good counter mentioned above) in the memory unit 8 of the image processing unit 6. Subsequently the individual line quality values 21, 21′. . . are added using the quality value module 17 to an overall quality value for the object edge module or the associated object 3.1-3.4 respectively. The overall quality value 22 is also stored in the memory unit 8 and subsequently used to indicate, the quality of the correspondence between the pattern object 4 and the object 3.1-3.4 to be examined, especially using the output device 10.

In addition to the line correlation described above, the image processing unit 6 or the data processing unit 7 of the inventive object identification system are further embodied to execute a so-called point tolerance correlation. In point tolerance correlation the best value of the edge orientation at right angles to the course of a line of the pattern, i.e. the best edge gradient is searched for. For this purpose an orientation threshold value is stored in the memory unit 23. The orientation threshold value 23 specifies which gradient an edge point of the object edge image must at least have in order, for the correlation by the correlation module 15 described above, to gain entry into a line quality value 21, 21′, . . . . In other words: An object edge point, of which the gradient lies below the orientation threshold value 23, is not taken into account for the summation to determine the corresponding line quality value 21, 21′, . . . . In conjunction with the line correlation described further above, this method leads to the efficiency of said correlation being further improved.

In order to further reduce the influence of “lower-value” edges on the overall quality value 22, in the correlation described above, an edge threshold value 24 stored in the memory unit 8 continues to be taken into account by using the correlation module 15. The edge threshold value 24 represents a threshold value for the strength of an edge point with which, if the corresponding point falls below the edge threshold value 24 it again remains unconsidered in the correlation and thus cannot have a negative effect on the line quality value 21, 21′, . . . or on the overall quality value 22. Accordingly the edge threshold value 24 has the same importance in relation to the edge strengths of an edge point as the orientation threshold value 23 in respect of the orientation of an edge point.

The threshold value module 16 of the image processing unit 6 or of the data processing unit 7 respectively serves inventively in this context to undertake an automatic adaptation of the edge threshold value 24 and/or of the orientation threshold value 23, in that corresponding algorithms are implemented in the threshold value module 16 which can continue also to take account of a total number of edge points found after completed recording of the pattern images by the edge module 12 (as well as corresponding thinning of the edges and connection by the line module 13). In particular the respective threshold value can be dependent on a standard deviation of the edge point found in the pattern in respect of edge strength and orientation.

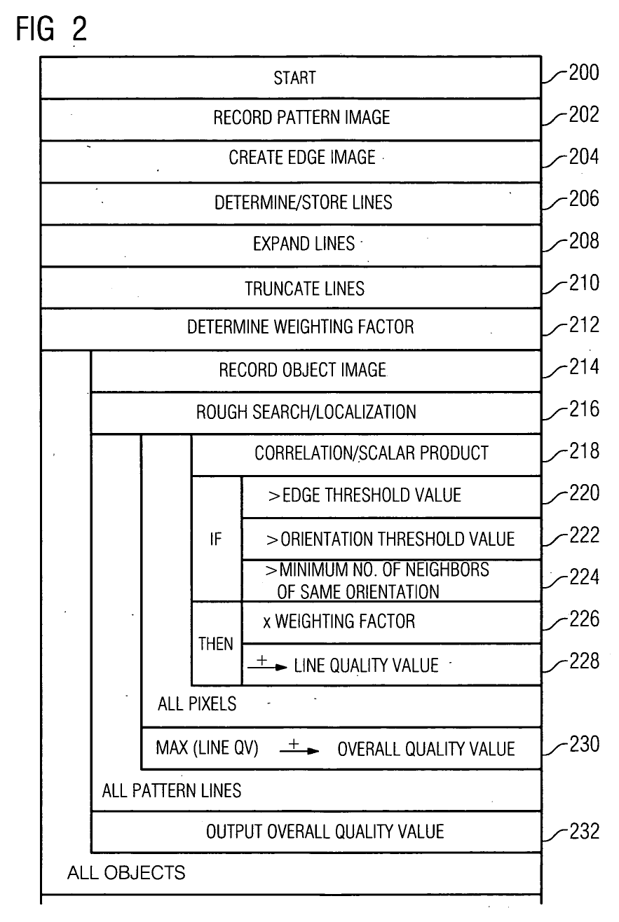

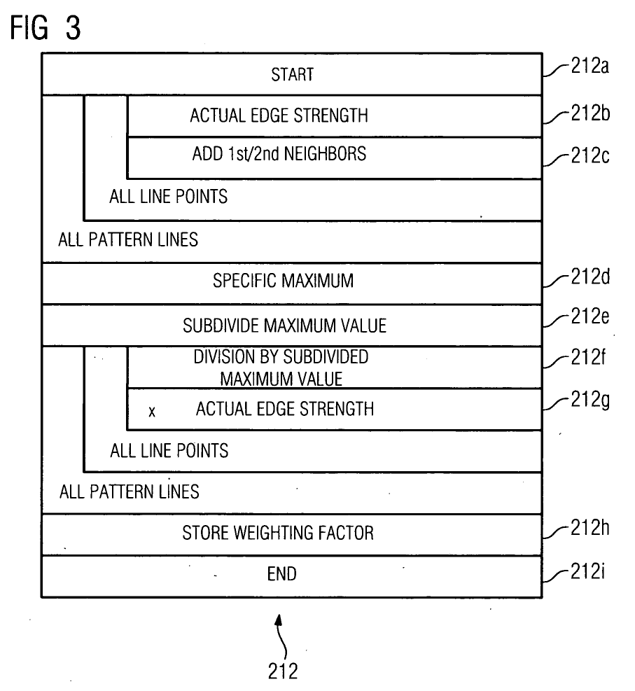

FIG. 2 uses a structured flowchart to show the execution sequence of an embodiment of the inventive method for identifying objects using an object identification system, especially an object identification system 1 in accordance with FIG. 1. The inventive method starts at step 200. In a subsequent step 202 the image of a pattern object is recorded. Then in step 204 edge points in the recorded pattern image are determined, i.e. the image is converted into an edge image. At the same time in step 204 suitable values for the edge threshold value and the orientation threshold value are determined, as described above. In a subsequent step 206 line of the patterns of the pattern edge image are determined and stored in a suitable form. As is shown with reference to method step 208, line fragments found subsequently, i.e. lines of which the number of edge points lies below the maximum value of typically 100 points introduced above, can be expanded to longer lines. This is especially the case, if within a longer line only individual or a few edge points are missing, to ensure a continuous course of the line. In the subsequent step 210 by contrast lines which are too long are truncated or divided up to achieve a tolerance in relation to image distortions, as has likewise already been described above. Subsequently in step 212 the weighting factor for the edge strengths is determined, via which the strength of individual edgesilines is weighted more strongly during the correlation. (A more detailed diagram of the method step 212 just described is the subject matter of the subsequent FIG. 3.)

After the relevant pattern has been taught to the system in this manner, in a subsequent step 214 the image is initially recorded of an object 3.1-3.4 (FIG. 1) to be identified or examined respectively and likewise converted into an edge image (object edge image). Subsequently a rough search is undertaken in step 216 in order to at least roughly localize an object possibly corresponding to the pattern object in the recorded image in respect of its location and its orientation and to accordingly specify an image area of the object edge image to which the inventive method is to be applied for (detailed) identification of objects. Such a rough search is regularly undertaken using what is known as a pyramid process in a number of stages with corresponding multiple undersampling of the images, which is known per se to the person skilled in the art.

Following step 216 the correlation between pattern and object for a line of the pattern over all pixels of the object edge image is initially determined according to the invention, by forming the scalar product between the relevant pattern and object edge points of their orientation respectively in step 218. The subsequent steps 220, 222, 224 each contain a query as to whether the determined value of the scalar product lies above the threshold value determined in step 204 (step 220) whether the gradient in the relevant object edge point lies above the orientation threshold value determined in step 204 (step 222) and whether a sufficient number of neighboring points belong to the same line of the pattern (step 224). Only if the answer to the three queries is yes will the relevant scalar product be taken into consideration in the determination of the associated line quality value for the line observed. If not, the relevant scalar product is discarded and the method is continued with the next object pixel in step 218. In the event of the answer to all three queries 220-224 being yes, the determined value of the scalar product is multiplied in step 226 by the weighting factors determined in step 212 and added in step 228 to the quality value for the observed line. As shown above, the weighting factor can alternately also already be contained in the stored pattern edge image or instead in the associated line data records.

Steps 218-228—as stated—are repeated for all pattern edge images and with the inclusion of specific tolerances—as described above. Subsequently in step 230 the maximum line quality value for the line involved is determined from the line quality values determined in this way. If this method is concluded for all line of the patterns found, the individual line quality values are added to an overall quality value for the pattern-object comparison and the overall quality value is output in step 232. Subsequently a new object can be recorded and compared. The inventive method ends in step 234, if either no further object is available or if a new pattern is to be taught.

FIG. 3 uses a further structured flowchart to show the execution sequence of method step 212 in accordance with FIG. 2 in greater detail. The individual substeps of the method are labeled in FIG. 3 with the reference symbol 212 and the appended lower-case letters a, b, c,.

The method begins in step 212a. The starting value for determining the weighting factor 20 (FIG. 1) is in step 212b the actual edge strength in a specific pattern pixel. Added to this in step 212c are the corresponding values of the edge strengths for the first and second neighbors of this point, i.e. the edge strengths of those edge points which were previously lost on thinning of the line of the pattern. This method is continued until all line points have been taken into account. This procedure is run for all found line of the patterns. Subsequently, in step 212d, the maximum value for the summed (expanded) edge strengths established in this way is determined. For numerical reasons this maximum value is divided in a subsequent step 212e by a fixed, predetermined value, for example by the value four. The maximum value subdivided in this way is used in a subsequent step 212f, which once again is repeated for all lines and all line points, in order to reduce the edge strengths of each edge value further or to normalize them. In a subsequent step 212g all line points of all lines are then multiplied by the original value of the edge strength at this point, so that in this way a pseudo-quadratic weighting of the individual edge points or edge strengths is achieved during correlation. The weighting factor for each pattern edge point established in this way is stored (step 212h; either separately or directly in the pattern edge image) and is thus available—as described above—for subsequent weighting of the edge strength in the calculation. The (sub)method ends with step 212i.

In this way the invention achieves its object of correctly weighting specific regions of the image for an pattern-object comparison to be conducted automatically. This especially produces an increase in the signal-to-noise ratio, i.e. an increase of the distance between good and bad identification, since especially isolated good pixels and/or a large number of “lower-value” edges no longer disproportionately drive up the overall quality value of a comparison. This means that the invention makes a secure classification of good and bad parts possible. In addition, because of the truncation of lines, distortions within the pattern are tolerated to an extent, so that especially the size of the pattern now only plays a small part in the quality expression.

1-12. (canceled)

13. A method for identifying objects using an object identification system, comprising:
recording an image of an object to be identified by an image recording unit;
teaching a respective pattern of the object to be identified to the object processing system in the form of a pattern edge image formed from edge points; and
comparing edge points in the recorded image with edge points of the pattern edge image for a match of a relevant pattern, wherein an overall quality value is determined as a measure of the correspondence between the object and the pattern, wherein
an association with lines in the pattern is then determined for the edge points of the pattern by finding edge points with essentially the same orientation, and that an edge point in the recorded image is assessed as belonging to an object that corresponds to the pattern if a predetermined number of neighboring edge points adjacent to the relevant edge point have an orientation that essentially corresponds to the orientation of a line in the pattern.

14. The method as claimed in claim 13, wherein
for each edge point assessed as belonging to an object corresponding to the pattern, a line quality value is increased.

15. The method as claimed in claim 14, wherein
each line of the pattern is compared individually with edge points of the recorded image and a corresponding maximum line quality value is added to the overall quality value.

16. The method as claimed in claim 15, wherein
during the comparison of edge points, a scalar product is formed from an orientation of a pattern edge point with an orientation of an edge point of the recorded image, with a corresponding value of the scalar product before recording being weighted in a line quality value with a weighting factor.

17. The method as claimed in claim 16, wherein
a determination of the weighting factor starting from an initial value comprises:
adding an actual edge strength in the edge points of a line of the pattern to the initial value,
adding a respective edge strength of neighboring edge points of the relevant edge points of the line of the pattern not previously taken into consideration for determining an expanded edge strength of the line of the pattern in each case,
repeating the previous steps for all lines of the patterns and determining a maximum value for the expanded edge strength of the lines of the pattern,
normalizing the values for the edge strength of all edge points to the maximum value, and
multiplying all normalized values for the edge strength by the value for the actual edge strength in the corresponding edge point.

18. The method as claimed in claim 17, wherein
a length of the lines of the pattern is limited to a predetermined maximum value.

19. The method as claimed in claim 18, wherein
for a number of edge points in the recorded image, an orientation value at right angles to a line of the pattern is compared with a predetermined orientation threshold, and that only edge points with an orientation value exceeding the orientation threshold value are included in the determination of the overall quality value.

20. The method as claimed in claim 18, wherein
for a number of edge points in the recorded image an edge threshold value is set and that only those edge points are included in the determination of the overall quality value of which the contribution to the edge strength exceeds the edge threshold value.

21. The method as claimed in claim 19, wherein
the orientation threshold value and/or the edge threshold value are generated automatically as a function of a number of found edge points in the recorded image.

22. The method as claimed in claim 20, wherein the orientation threshold value and/or the edge threshold value are generated automatically as a function of a number of found edge points in the recorded image.

23. The method as claimed in claim 21, wherein line fragments of the pattern are expanded into complete lines before the comparison.

24. The method as claimed in claim 22, wherein line fragments of the pattern are expanded into complete lines before the comparison.

25. An object identification system, comprising:
an image recording unit that records pattern images and object images; and
an image processing unit that receives the recorded image and creates edge images from the recorded pattern images and object images,
wherein at least one pattern of an object to be searched for a recorded image in the form of an edge image comprising edge points is taught for a comparison with edge points in the recorded image, through which an overall quality value for a correspondence between the object and the pattern is determined.

26. A computer program product for use in an object identification system having an image recording unit that records a pattern and object images and with an image processing unit that creates an edge image from the recorded pattern and object images, with at least one pattern of an object to be searched for in the form of an edge image comprising edge points learned in the object identification system, comprising:
a plurality of computer code sequences stored for execution in a digital computer, comprising
storing a recorded image of a of an object to be identified by the image recording unit,
determining a respective pattern of the object to be identified to the object processing system in the form of a pattern edge image formed from edge points, and
comparing edge points in the recorded image with edge points of the pattern edge image for a match of a relevant pattern, wherein an overall quality value is determined as a measure of the correspondence between the object and the pattern, wherein
an association with lines in the pattern is then determined for the edge points of the pattern by finding edge points with essentially the same orientation, and that an edge point in the recorded image is assessed as belonging to an object that corresponds to the pattern if a predetermined number of neighboring edge points adjacent to the relevant edge point have an orientation that essentially corresponds to the orientation of a line in the pattern.
